(19) United States
(12) Patent Application Publication
(10) Pub. No.: US 2024/0395002 A1
(43) Pub. Date: Nov. 28, 2024

(54) TWO-DIMENSIONAL MAP GENERATION METHOD, DEVICE, TERMINAL DEVICE AND STORAGE MEDIUM

(71) Applicant: ORBBEC INC., Shenzhen (CN)

(72) Inventors: Zirong CHEN, Shenzhen (CN); Lin WANG, Shenzhen (CN)

(21) Appl. No.: 18/592,153

(22) Filed: Feb. 29, 2024

Related U.S. Application Data
(63) Continuation of application No. PCT/CN22/80520, filed on Mar. 13, 2022.

(30) Foreign Application Priority Data
Sep. 24, 2021 (CN) 202111122466.5

(51) Int. Cl. G06V 10/25; G06T 7/70; G06T 17/00; G06V 20/70

(52) U.S. Cl. CPC G06V 10/25; G06T 7/70; G06T 17/00; G06V 20/70; G06T 2207/10024

(57) ABSTRACT

A method for generating a two-dimensional map, includes: obtaining a depth image and a color image of a target scene, and determining a mapping relationship between the depth image and the color image; obtaining a two-dimensional point cloud image according to the depth image, and determining a target map box corresponding to the two-dimensional point cloud image; and obtaining position label information in each region in the target map box, and according to the position label information and the mapping relationship, correlating the position label information to first pose information of a first color camera corresponding to a color image in each region to obtain a two-dimensional map.

### CROSS-REFERENCE TO RELATED APPLICATIONS

This application is a Continuation application of International Patent Application No. PCT/CN2022/080520, filed on Mar. 13, 2022, which is based on and claims priority to and benefits of Chinese Patent Application No. 202111122466.5, filed on Sep. 24, 2021. The entire content of all of the above-identified applications is incorporated herein by reference.

### TECHNICAL FIELD

This application relates to the field of positioning technologies, and in particular, to a two-dimensional map generation method and apparatus, a terminal device, and a storage medium.

### BACKGROUND

Most of location positioning services on existing mobile devices (such as mobile phones) are based on the location fusion technology, which includes GPS signals, cellular network base station signals, and the like, and can provide more accurate positioning when used in indoor and outdoor scenes. The positioning is to position a physical location in the world, which may be a country, a city, a district, or a street.

However, the current location positioning services are basically provided by telecom operators, or proprietary companies that cooperate with the telecom operators. Furthermore, if the location positioning service is required to be embedded into another system (for example, an APP having a related positioning function) for use, in addition to paying the service providers needs to be used for development. The development is performed in a complex process, and an overall development progress may stagnate due to over-reliance on current location positioning services, affecting use of the positioning services by users.

In view of this, existing technologies need to be further alleviated and improved.

### SUMMARY

Embodiments of this application provide a two-dimensional map generation method and apparatus, a terminal device, and a storage medium, to resolve problems in the existing technologies such as complex processes and a slow progress in a process of developing a positioning function.

In order to resolve the foregoing technical problems, technical solutions adopted in this application are as follows.

According to a first aspect, this application provides a two-dimensional map generation method, including: obtaining a depth image and a color image of a target scene, and determining a mapping relationship between the depth image and the color image; obtaining a two-dimensional point cloud image according to the depth image, and determining a target map box corresponding to the two-dimensional point cloud image; and obtaining position label information in each region in the target map box, and according to the position label information and the mapping relationship, correlating the position label information to first pose information of a first color camera corresponding to a color image in each region to obtain a two-dimensional map.

In an embodiment, the obtaining a depth image and a color image of a target scene, and determining a mapping relationship between the depth image and the color image includes: in response to obtaining one frame of the depth image of the target scene, obtaining one frame of the color image; obtaining first pixel information of the color image and second pixel information of the depth image; and determining the mapping relationship between the depth image and the color image according to the first pixel information and the second pixel information.

In an embodiment, the obtaining a depth image and a color image of a target scene, and determining a mapping relationship between the depth image and the color image further includes: obtaining second pose information of a second color camera corresponding to the color image and third pose information of a depth camera corresponding to the depth image; and associating the second pose information of the second color camera corresponding to the color image with the third pose information of the depth camera corresponding to the depth image according to the mapping relationship.

In an embodiment, the obtaining a two-dimensional point cloud image according to the depth image, and determining a target map box corresponding to the two-dimensional point cloud image includes: converting the depth image into three-dimensional point cloud data, wherein the three-dimensional point cloud data carries different color identifiers; obtaining the two-dimensional point cloud image by using the three-dimensional point cloud data; and determining the target map box according to the two-dimensional point cloud image.

In an embodiment, the determining the target map box according to the two-dimensional point cloud image includes: determining, according to the two-dimensional point cloud image, coordinate information of each track point in the two-dimensional point cloud image; determining a maximum horizontal coordinate point, a minimum horizontal coordinate point, a maximum vertical coordinate point, and a minimum vertical coordinate point based on the coordinate information of each track point; and determining a rectangular bounding box according to the maximum horizontal coordinate point, the minimum horizontal coordinate point, the maximum vertical coordinate point, and the minimum vertical coordinate point, and using the rectangular bounding box as the target map box.

In an embodiment, the determining the target map box according to the two-dimensional point cloud image further includes: modifying the target map box by aligning the target map box with a coordinate system corresponding to the coordinate information.

In an embodiment, the obtaining position label information in each region in the target map box includes: performing a gridding operation on the target map box to obtain each region in the target map box; obtaining boundary information of each region, position information of each track point in each region, and a projection relationship between each track point in each region and three-dimensional point cloud data; and using the boundary information of each region, the position information of each track point in each region, and the projection relationship between each track point in each region and the three-dimensional point cloud data as the position label information.

According to a second aspect, an embodiment of this application further provides a two-dimensional map generation apparatus for positioning, including: an image capture module, configured to capture a depth image and a color image of a target scene; a mapping relationship determining module, configured to determine a mapping relationship between the depth image and the color image; a target map box determining module, configured to obtain a two-dimensional point cloud image according to the depth image, and determine a target map box corresponding to the two-dimensional point cloud image; and a two-dimensional map generation module, configured to obtain position label information in each region in the target map box, and according to the position label information and the mapping relationship, correlating the position label information to first pose information of a first color camera corresponding to a color image in each region according to the position label information and the mapping relationship, to obtain the two-dimensional map.

According to a third aspect, an embodiment of this application further provides a terminal device, including a memory, a processor, and a program stored in the memory and executable on the processor. The processor, when executing the program, implements the steps of the methods according to any one of the foregoing solutions.

According to a fourth aspect, an embodiment of this application further provides a non-transitory computer-readable storage medium, storing a program. The program, when executed by a processor, causes the processor to implement the steps of the methods according to any one of the foregoing solutions.

Beneficial effects of the embodiments of the application are as follows. Compared with the existing technologies, the technical solutions disclosed herein provide a method for two-dimensional map generation. A depth image and a color image of a target scene are first obtained. Since the depth image and the color image are obtained based on the same target scene, a mapping relationship between the depth image and the color image may be determined. Since the images may be converted into point cloud data through coordinates, a two-dimensional point cloud image corresponding to the depth image may be obtained, and a target map box corresponding to the two-dimensional point cloud image may be determined, where the target map box includes point cloud data of the target scene. Further, in this application, position label information of each region in the target map box is obtained, where the position label information is used for indicating position information of each track point of each region in the target map box. The two-dimensional point cloud image is obtained based on processing the depth image, and there is a mapping relationship between the depth image and the color image. Therefore, in this application, the position label information may be bound/correlated to pose information of a color camera corresponding to a color image in each region based on the mapping relationship, to obtain a two-dimensional map. The generated two-dimensional map may include position information of each track point in each region. In this way, after a user obtains a color image of the same target scene, the pose information of the corresponding color camera may be obtained, and the corresponding position label information may be further obtained based on the two-dimensional map, thereby achieving accurate positioning. It can be seen that, in this application, a two-dimensional map can be quickly generated in a simple process, and the generated two-dimensional map can be reused, which provides more convenient positioning services for the user.

### BRIEF DESCRIPTION OF THE DRAWINGS

FIG. 1 is a flowchart of an implementation of a two-dimensional map generation method according to an embodiment of this application.

FIG. 2 is a schematic diagram of camera tracks of a floor building in a target scene in a two-dimensional map generation method according to an embodiment of this application.

FIG. 3 is a schematic of a side view of camera tracks of a floor building in a target scene in a two-dimensional map generation method according to an embodiment of this application.

FIG. 4 is a schematic diagram of a two-dimensional point cloud image of a floor building in a target scene in a two-dimensional map generation method according to an embodiment of this application.

FIG. 5 is a schematic diagram of a target map box determined from the two-dimensional point cloud image in FIG. 4 in a two-dimensional map generation method according to an embodiment of this application.

FIG. 6 is a schematic diagram of performing gridding operation on the target map box in FIG. 5 in a two-dimensional map generation method according to an embodiment of this application.

FIG. 7 is a schematic diagram of camera tracks of one floor in a floor building in a two-dimensional map generation method according to an embodiment of this application.

FIG. 8 is a block diagram of a two-dimensional map generation apparatus according to an embodiment of this application.

FIG. 9 is a block diagram of an internal structure of a terminal device according to an embodiment of this application.

### DETAILED DESCRIPTION

To make the objectives, technical solutions, and effects of this application clearer and more explicit, the following further describes this application with reference to the accompanying drawings and embodiments. It should be understood that the embodiments described herein are merely used for explaining this application but do not limit this application.

In an embodiment, a two-dimensional map generation method is provided. According to the two-dimensional map generation method, a two-dimensional map can be quickly generated in a simple process, and the generated two-dimensional map can be reused, which provides more convenient positioning services for a user. In an embodiment, a depth image and a color image of a target scene are first obtained. Since the depth image and the color image are obtained based on the same target scene, a mapping relationship between the depth image and the color image may be determined. Since the images may be converted into point cloud data through coordinates, in an embodiment, a two-dimensional point cloud image corresponding to the depth image may be obtained, and a target map box corresponding to the two-dimensional point cloud image may be determined, where the target map box may include some or all point cloud data of the target scene. Further, in an embodiment, position label information of each region in the target map box is obtained, where the position label information is used for indicating position information of each track point of each region in the target map.

Further, the two-dimensional point cloud image is obtained based on processing the depth image, and there is a mapping relationship between the depth image and the color image. Therefore, in an embodiment, the position label information may be bound/correlated to pose information of a color camera corresponding to a color image in each region based on the mapping relationship, to obtain a two-dimensional map. The generated two-dimensional map may include position information of each track point in each region. In this way, after a user obtains a color image of the same target scene, the pose information of the corresponding color camera may be obtained, and the corresponding position label information may be further obtained based on the two-dimensional map, thereby achieving accurate positioning.

For example, when the target scene is a multi-floor building (such as a 3-floor building), a depth image and a color image of the 3-floor building may be obtained, and then a mapping relationship between the depth image and the color image is determined. Then, a corresponding two-dimensional point cloud image is obtained according to the depth image of the 3-floor building, and a target map box is determined, where the target map box may include some or all point cloud data of the 3-floor building. Further, position label information of each region in the target map box is obtained, where the position label information may indicate position information of each track point on each floor in the 3-floor building. Therefore, the position label information may be bound/correlated to pose information of a color camera corresponding to a color image in each region, to obtain a two-dimensional map of the 3-floor building. After the user obtains the color image of the 3-floor building, the pose information of the corresponding color camera may be obtained, and the corresponding position label information may be further obtained according to the two-dimensional map of the 3-floor building, that is, the position and the floor are obtained, thereby achieving accurate positioning.

### Exemplary Method

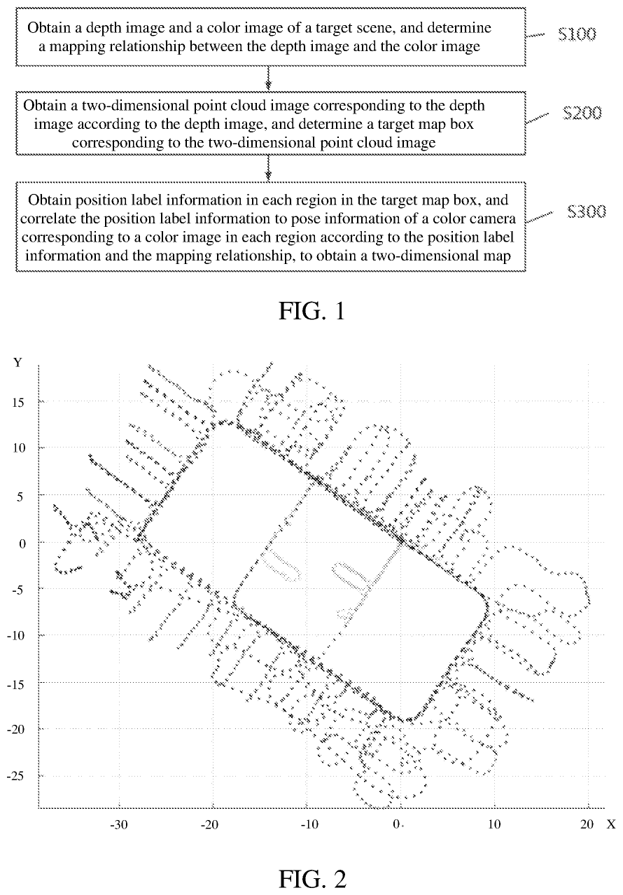

In an embodiment, the two-dimensional map generation method is applicable to a terminal device. The terminal device may be a smart product such as a computer, a mobile phone, or a tablet. For example, as shown in FIG. 1, the two-dimensional map generation method includes the following steps.
Step S100: Obtain a depth image and a color image of a target scene, and determine a mapping relationship between the depth image and the color image.

The depth image may also be referred to as a range image, which is an image that uses ranges (depths) between a depth camera and points in the target scene as pixel values, and directly indicates a geometric shape of a visible surface in the target scene. The depth image may be calculated as point cloud data after coordinate conversion, and the point cloud data having rules and necessary information may also be reversely calculated as the depth image. In an embodiment, the color image is an image captured by the color camera. In an embodiment, since the depth image and the color image are obtained based on the same target scene, the mapping relationship between the depth image and the color image may be determined after the depth image and the color image are obtained.

In an embodiment, the determining a mapping relationship between the depth image and the color image includes the following steps.
Step S101: Obtain one frame of color image, each time one frame of depth image of the target scene is obtained.
Step S102: Obtain first pixel information of the color image and second pixel information of the depth image.
Step S103: Determine the mapping relationship between the depth image and the color image according to the first pixel information and the second pixel information.

In an embodiment, a plurality of depth images and color images of the target scene are obtained synchronously, during obtaining the depth images and the color images. In other words, one frame of color image is obtained, each time one frame of depth image of the target scene is obtained. In this way, it can be ensured that the depth image and the color image are based on the same target scene at the same time point, to enable the obtained mapping relationship to be more accurate. The first pixel information of the color image and the second pixel information of the depth image are respectively obtained after the depth image and the color image are obtained. The depth image and the color image are based on the same target scene at the same time point. Therefore, in an embodiment, the depth image may be aligned with the color image, and then the mapping relationship between the depth image and the color image is determined according to the first pixel information and the second pixel information. In an embodiment, the mapping relationship is a mapping relationship between each pixel point in the depth image and the color image. In other words, the second pixel information of the depth image may be determined according to the mapping relationship when the first pixel information of the color image is known.

In addition, in an embodiment, pose information of a color camera corresponding to the color image and pose information of a depth camera corresponding to the depth image may be respectively obtained after the depth image and the color image are obtained. The pose information includes track points of the color camera and the depth camera. Since there is a mapping relationship between the depth image and the color image, in an embodiment, the pose information of the color camera corresponding to the color image may be associated with the pose information of the depth camera corresponding to the depth image according to the mapping relationship. Therefore, the pose information of the depth camera corresponding to the depth image may be determined when the pose information of the color camera corresponding to the color image is known.
Step S200: Obtain a two-dimensional point cloud image corresponding to the depth image according to the depth image, and determine a target map box corresponding to the two-dimensional point cloud image.

In an embodiment, the depth image may be calculated as point cloud data after coordinate conversion, while a two-dimensional map is to be generated. Therefore, in an embodiment, the depth image may be converted into a two-dimensional point cloud image, and then a target map box is determined from the two-dimensional point cloud image. In an embodiment, the target map box may contain some or all track points in the two-dimensional point cloud image, which facilitates the generation of the two-dimensional map based on the target map box in the subsequent steps.

In an embodiment, the determining a target map box includes the following steps.
Step S201: Convert the depth image into three-dimensional point cloud data, where the three-dimensional point cloud data carries different color identifiers.
Step S202: Obtain the two-dimensional point cloud image by using the three-dimensional point cloud data carrying the different color identifiers.
Step S203: Determine the target map box according to the two-dimensional point cloud image.

In an embodiment, the depth image is first converted into the three-dimensional point cloud data. For example, in an embodiment, pixel information (that is, the second pixel information) of each pixel point in the depth image is first obtained, and then the three-dimensional point cloud data is calculated as follows:

$$\{ \begin{matrix}{x}_{s} = z \cdot ( u - {u}_{0} ) \cdot \frac{dx}{{f}^{′}} \\ {y}_{s} = z \cdot ( v - {v}_{0} ) \cdot \frac{dy}{{f}^{′}} \\ {z}_{s} = z\end{matrix}$$

where (xₛ, yₛ, zₛ) are point cloud three-dimensional coordinates in a depth camera coordinate system, z is a depth of each pixel, (u, v) are pixel coordinates, (u₀, v₀) are coordinates of a principal point of an image, dₓ and d_{y} are physical sizes of a sensor pixel of the depth camera in two directions, and f′ is a focal length (in a unit of millimeter).

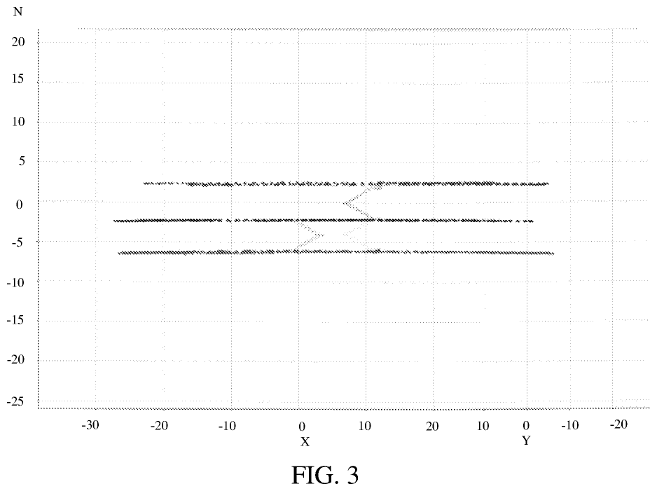

For ease of identifying positions of track points in the three-dimensional point cloud data and distinguishing the track points, in an embodiment, the three-dimensional point cloud data carries different color identifiers. For example, if the target scene is a multi-floor building (such as a 3-floor building), when a color image of the multi-floor building is obtained, different color identifiers may be set for corresponding track points for obtaining the color image, to distinguish and calculate data. In an embodiment, different color identifiers are set for the track points on each floor, as shown by the camera track of a multi-floor building in a target scene in FIG. 2 and FIG. 3. It can be seen from FIG. 3 that, 6 blocks correspond to data of 3 floors and 3 stairs. In addition, a Z-axis direction of the data is approximated to a direction of gravity, that is, a horizontal direction is consistent with an XY plane of the point cloud data. In an embodiment, track points of each floor are distinguished by using different color identifiers. In this way, during subsequent processing and calculation of the three-dimensional point cloud data, region division may be implemented based on different units such as different color identifiers, to implement the data calculation and the transmission on a per-region basis, thereby resolving problems such as a large volume of the complete data and a slow transmission speed.

In addition, it is to be noted that, in an embodiment, the three-dimensional point cloud data may also not carry color identifiers, but the problems such as a larger data volume and a slow calculation processing speed may still occur, which is not limited herein.

In an embodiment, when the three-dimensional point cloud data is processed to obtain the two-dimensional point cloud image, depths of the three-dimensional point cloud data may be directly discarded, or the three-dimensional point cloud data may be normalized in a z-axis, where a normalized coordinate is

$$[ \begin{matrix}X / Z \\ Y / Z \\ 1\end{matrix} ] .$$

It can be seen that, normalized coordinate information represents that a z-axis coordinate is 1, to further obtain the two-dimensional point cloud image. It is to be noted that, the normalized z-axis coordinate may also be any other value as long as the normalized point cloud is a plane, which is not limited herein.

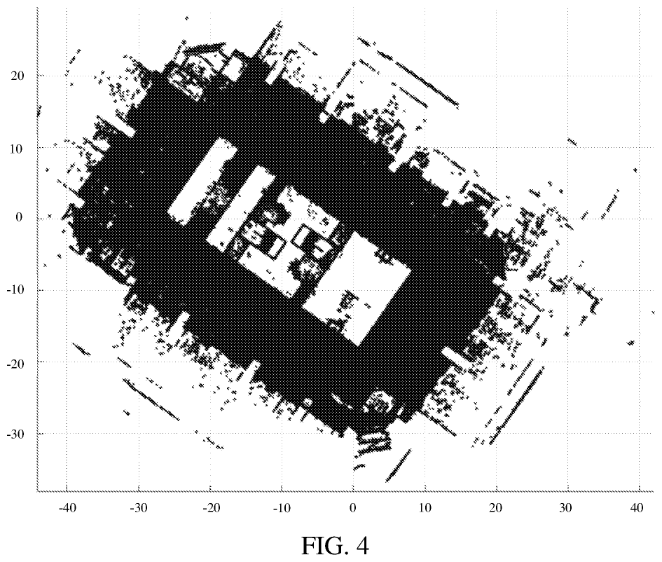

In another embodiment, after three-dimensional point cloud data carrying different color identifiers is obtained, the three-dimensional point cloud data carrying the different color identifiers is projected to the same coordinate system (an X-Y coordinate system), to obtain a two-dimensional point cloud image in the same coordinate system, which is shown in FIG. 4. Since the two-dimensional point cloud image is obtained by projecting the three-dimensional point cloud data, there is a projection relationship between the two-dimensional point cloud image and the three-dimensional point cloud data. In an embodiment, after the two-dimensional point cloud image is obtained, noise reduction is performed on the two-dimensional point cloud image. For example, in an embodiment, the X-Y coordinate system is established, a grid of 20 cm is used as a unit for calculating a point density in the grid, and then median filtering is performed on the point density in the grid, to effectively remove flying pixels, thereby implementing noise reduction on the two-dimensional point cloud image.

In an embodiment, after the two-dimensional point cloud image is obtained, the target map box is determined from the two-dimensional point cloud image. The target map box may contain some or all track points in the two-dimensional point cloud image, and the target map box may be set as a rectangular bounding box in an application. To discard useless data and make sure all data in the target map box to be useful, in an embodiment, the target map box may be set as a minimum bounding rectangle that contains all track points in the two-dimensional point cloud image, where the minimum bounding rectangle is a maximum range that can be used to contain all the track points in the two-dimensional point cloud image.

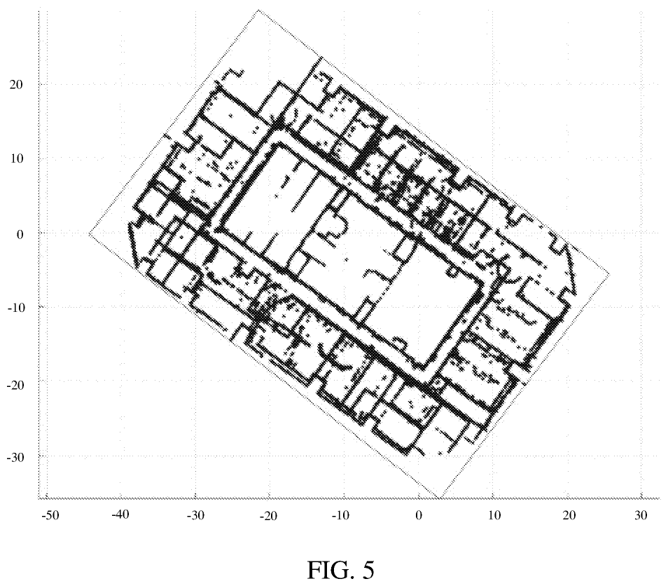

For example, in an embodiment, when the target map box is determined, coordinate information of each track point in the two-dimensional point cloud image is first determined according to the two-dimensional point cloud image. Then, a maximum horizontal coordinate point, a minimum horizontal coordinate point, a maximum vertical coordinate point, and a minimum vertical coordinate point are determined based on the coordinate information of each track point. Finally, a rectangular bounding box, that is, a minimum bounding rectangle is determined according to the maximum horizontal coordinate point, the minimum horizontal coordinate point, the maximum vertical coordinate point, and the minimum vertical coordinate point, and the rectangular bounding box is used as the target map box, which is shown in FIG. 5. In an embodiment, when a boundary and a direction of the rectangular bounding box are determined, a decentralized covariance matrix may be calculated for each track point in the two-dimensional point cloud image, an operation such as SVD decomposition may be performed on the covariance matrix, to calculate feature vectors corresponding to two eigenvalues and obtain two directions of the rectangular bounding box, and then boundary values in the two directions are obtained for the track points in the two-dimensional point cloud image, to determine the boundary of the rectangular bounding box.

In an embodiment, the rectangular bounding box may also be enlarged based on different target scenes. For example, when exactly located at a boundary of a space that can be expressed on the map, the rectangular bounding box may be enlarged to enable the rectangular bounding box to express more information. In addition, if the rectangular bounding box is not aligned with the X-Y coordinate system in the foregoing steps for projecting the three-dimensional point cloud data to obtain the two-dimensional point cloud image, the target map box may be modified, to align the target map box with the X-Y coordinate system, and to facilitate the gridding operation performed on the target map box in the subsequent steps.
Step S300: Obtain position label information in each region in the target map box, and correlate the position label information to pose information of a color camera corresponding to a color image in each region according to the position label information and the mapping relationship, to obtain a two-dimensional map.

After the target map box is obtained, to analyze track points in the target map box, in an embodiment, the target map box is divided into regions, and position label information of each region in the target map box is obtained. The position label information indicates position information of each track point of each region in the target map. The two-dimensional point cloud image is obtained based on processing the depth image, and there is a mapping relationship between the depth image and the color image. Therefore, in an embodiment, the position label information may be bound/correlated to pose information of a color camera corresponding to a color image in each region based on the mapping relationship, to obtain a two-dimensional map.

In an embodiment, the obtaining position label information includes the following steps.
Step S301: Perform a gridding operation on the target map box to obtain each region in the target map box.
Step S302: Obtain boundary information of each region, position information of each track point in each region, and a projection relationship between each track point in each region and three-dimensional point cloud data.
Step S303: Use the boundary information of each region, the position information of each track point in each region, and the projection relationship between each track point in each region, and the three-dimensional point cloud data as the position label information.

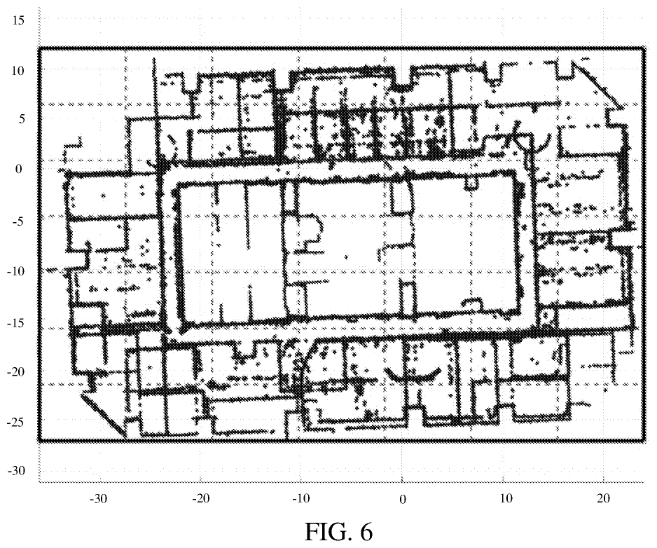

For example, since the target map box in an embodiment is a rectangular bounding box, the rectangular bounding box may be evenly divided into grids, where a quantity of divided grids may be determined according to the size of the target scene corresponding to the two-dimensional point cloud image and positioning precision. If the actual positioning precision is required to be higher, there are a larger quantity of grids obtained by dividing the rectangular bounding box, to precisely correspond to pose information of a camera corresponding to each grid in the subsequent steps. In an embodiment, after the gridding operation is performed on the target map box, the obtained regions in the target map box are shown in FIG. 6. Dashed lines in FIG. 6 are boundaries of grids, and each grid is a region. Since the grids are evenly divided, boundary information of each region may be obtained.

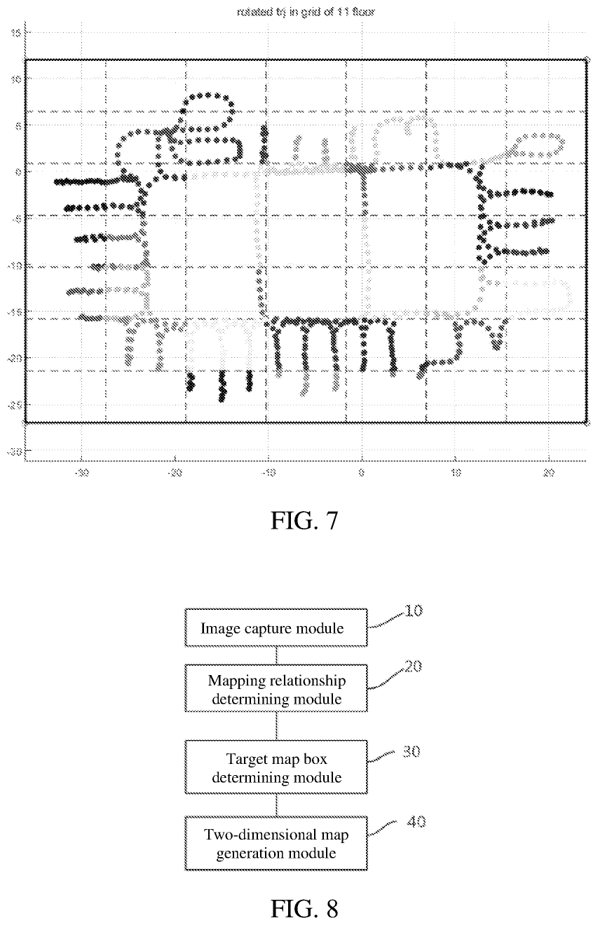

In an embodiment, each region is numbered based on the boundary information of each region, and each grid in the target map box is numbered. Then, boundary information of each region, position information of each track point in each region, and a projection relationship between each track point in each region and three-dimensional point cloud data are obtained, and the obtained boundary information of each region, position information (for example, floor information) of each track point in each region, and projection relationship between each track point in each region and three-dimensional point cloud data are set as the position label information. In this way, the position label information of each region in the target map box can be obtained. The two-dimensional point cloud image is obtained based on processing the depth image, and there is a mapping relationship between the depth image and the color image. Therefore, in an embodiment, the position label information may be correlated to pose information of a color camera corresponding to a color image in each region based on the mapping relationship, to obtain a two-dimensional map. FIG. 7 shows camera tracks of one floor when the target scene is a 3-floor building, and different colors are used in the diagram of camera tracks to represent that the track points are located in different grid regions, that is, the obtained two-dimensional map.

In an embodiment, the two-dimensional map generated may include position information of each track point in each region. In this way, after a user obtains a color image of the same target scene, the pose information (and track points) of the corresponding color camera may be obtained, and the corresponding position label information may be further obtained based on the two-dimensional map, thereby achieving accurate positioning. It can be seen that, in an embodiment, a two-dimensional map can be quickly generated in a simple process, and the generated two-dimensional map can be reused, which provides more convenient positioning services for the user.

### Exemplary Apparatus

Based on the foregoing embodiments, an embodiment further provides a two-dimensional map generation apparatus, as shown in FIG. 8. The apparatus includes: an image capture module 10, a mapping relationship determining module 20, a target map box determining module 30, and a two-dimensional map generation module 40. For example, the image capture module 10 is configured to capture a depth image and a color image of a target scene; the mapping relationship determining module 20 is configured to determine a mapping relationship between the depth image and the color image; the target map box determining module 30 is configured to obtain a two-dimensional point cloud image corresponding to the depth image according to the depth image, and determine a target map box corresponding to the two-dimensional point cloud image; and the two-dimensional map generation module 40 is configured to obtain position label information in each region in the target map box, and bind/correlate the position label information to pose information of a color camera corresponding to a color image in each region according to the position label information and the mapping relationship, to obtain a two-dimensional map.

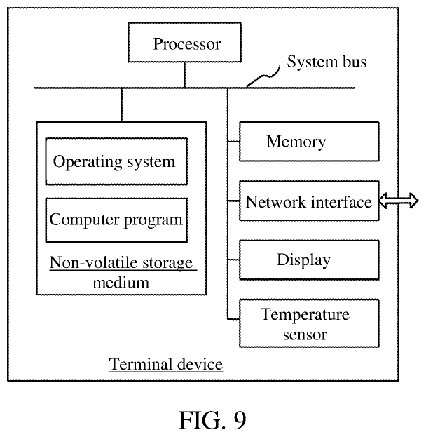

Based on the foregoing embodiments, this application further provides a terminal device. A block diagram of the terminal device may be shown in FIG. 9. The terminal device includes a processor, a memory, a network interface, a display, and a temperature sensor connected through a system bus. The processor of the terminal device is configured to provide computing and control functions. The memory of the terminal device includes a non-volatile storage medium and an internal memory. The non-volatile storage medium stores an operating system and a computer program. The internal memory provides an environment for execution of the operating system and the computer program in the non-volatile storage medium. The network interface of the terminal device is configured to communicate with an external terminal through a network connection. The computer program is executed by the processor to implement a two-dimensional map generation method. The display of the terminal device may be a liquid crystal display or an electronic ink display. The temperature sensor of the terminal device is pre-configured inside the terminal device to detect an operating temperature of an internal device.

A person of ordinary skill in the art may understand that a block diagram shown in FIG. 9 is merely a block diagram of a partial structure related to the solution of this application, and does not limit a terminal device to which the solution of this application is applied. A terminal device may include more or fewer parts, combination of some parts, or different part layouts than what is shown in the figure.

In an embodiment, a terminal device is provided, including a memory, a processor, and a two-dimensional map generation program stored in the memory and executable on the processor, the processor, when executing two-dimensional map generation program, implementing the following operation instructions:
obtaining a depth image and a color image of a target scene, and determining a mapping relationship between the depth image and the color image;
obtaining a two-dimensional point cloud image corresponding to the depth image according to the depth image, and determining a target map box corresponding to the two-dimensional point cloud image; and
obtaining position label information in each region in the target map box, and binding/correlating the position label information to pose information of a color camera corresponding to a color image in each region according to the position label information and the mapping relationship, to obtain a two-dimensional map.

A person of ordinary skill in the art may understand that all or some of procedures of the method in the foregoing embodiments may be implemented by a computer program instructing relevant hardware. The computer program may be stored in a non-volatile computer-readable storage medium which may be non-transitory. When the computer program is executed, the procedures of the foregoing method embodiments may be implemented. Any reference to a memory, a storage, a database, or another medium used in the embodiments provided in this application can include a non-volatile and/or volatile memory.

The non-volatile memory may include a read-only memory (ROM), a programmable ROM (PROM), an electrically programmable ROM (EPROM), an electrically erasable programmable ROM (EEPROM) or a flash memory. The volatile memory may include a random access memory (RAM) or an external cache. As an illustration instead of a limitation, the RAM is available in a plurality of forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link DRAM (SLDRAM), a Rambus direct RAM (RDRAM), a direct Rambus dynamic RAM (DRDRAM), and a Rambus dynamic RAM (RDRAM).

Based on the above, this application discloses a two-dimensional map generation method and apparatus, a terminal device, and a storage medium. The method includes: obtaining a depth image and a color image of a target scene, and determining a mapping relationship between the depth image and the color image; obtaining a two-dimensional point cloud image corresponding to the depth image according to the depth image, and determining a target map box corresponding to the two-dimensional point cloud image; and obtaining position label information in each region in the target map box, and binding/correlating the position label information to pose information of a color camera corresponding to a color image in each region according to the position label information and the mapping relationship, to obtain a two-dimensional map. In this application, a two-dimensional map can be quickly constructed, and the constructed two-dimensional map can be reused.

Finally, it should be noted that the foregoing embodiments are merely used for describing the technical solutions of this application, but do not limit this application. It should be understood by a person of ordinary skill in the art that although this application has been described in detail with reference to the foregoing embodiments, modifications can still be made to the technical solutions described in the foregoing embodiments, or equivalent replacements can be made to some technical features in the technical solutions, as long as such modifications or replacements do not cause the essence of corresponding technical solutions to depart from the spirit and scope of the technical solutions of the embodiments of this application.

What is claimed is:

1. A method for generating a two-dimensional map, comprising:
obtaining a depth image and a color image of a target scene, and determining a mapping relationship between the depth image and the color image;
obtaining a two-dimensional point cloud image according to the depth image, and determining a target map box corresponding to the two-dimensional point cloud image; and
obtaining position label information in each region in the target map box, and according to the position label information and the mapping relationship, correlating the position label information to first pose information of a first color camera corresponding to a color image in each region to obtain the two-dimensional map.

2. The method according to claim 1, wherein the obtaining a depth image and a color image of a target scene, and determining a mapping relationship between the depth image and the color image comprises:
in response to obtaining one frame of the depth image of the target scene, obtaining one frame of the color image;
obtaining first pixel information of the color image and second pixel information of the depth image; and
determining the mapping relationship between the depth image and the color image according to the first pixel information and the second pixel information.

3. The method according to claim 2, wherein the obtaining a depth image and a color image of a target scene, and determining a mapping relationship between the depth image and the color image further comprises:
obtaining second pose information of a second color camera corresponding to the color image and third pose information of a depth camera corresponding to the depth image; and
associating the second pose information of the second color camera corresponding to the color image with the third pose information of the depth camera corresponding to the depth image according to the mapping relationship.

4. The method according to claim 1, wherein the obtaining a two-dimensional point cloud image according to the depth image, and determining a target map box corresponding to the two-dimensional point cloud image comprises:
converting the depth image into three-dimensional point cloud data, wherein the three-dimensional point cloud data carries different color identifiers;
obtaining the two-dimensional point cloud image by using the three-dimensional point cloud data; and
determining the target map box according to the two-dimensional point cloud image.

5. The method according to claim 4, wherein the determining the target map box according to the two-dimensional point cloud image comprises:
determining, according to the two-dimensional point cloud image, coordinate information of each track point in the two-dimensional point cloud image;
determining a maximum horizontal coordinate point, a minimum horizontal coordinate point, a maximum vertical coordinate point, and a minimum vertical coordinate point based on the coordinate information of each track point; and
determining a rectangular bounding box according to the maximum horizontal coordinate point, the minimum horizontal coordinate point, the maximum vertical coordinate point, and the minimum vertical coordinate point, and using the rectangular bounding box as the target map box.

6. The method according to claim 5, wherein the determining the target map box according to the two-dimensional point cloud image further comprises:
modifying the target map box by aligning the target map box with a coordinate system corresponding to the coordinate information.

7. The method according to claim 4, wherein the obtaining position label information in each region in the target map box comprises:
performing a gridding operation on the target map box to obtain each region in the target map box;
obtaining boundary information of each region, position information of each track point in each region, and a projection relationship between each track point in each region and the three-dimensional point cloud data; and
using the boundary information of each region, the position information of each track point in each region, and the projection relationship between each track point in each region and the three-dimensional point cloud data as the position label information.

8. A terminal device for generating a two-dimensional map, comprising a memory, a processor, and a program stored in the memory and executable on the processor, wherein the processor, when executing the program, performs operations comprising:
obtaining a depth image and a color image of a target scene, and determining a mapping relationship between the depth image and the color image;
obtaining a two-dimensional point cloud image according to the depth image, and determining a target map box corresponding to the two-dimensional point cloud image; and
obtaining position label information in each region in the target map box, and according to the position label information and the mapping relationship, correlating the position label information to first pose information of a first color camera corresponding to a color image in each region to obtain the two-dimensional map.

9. The device according to claim 8, wherein the obtaining a depth image and a color image of a target scene, and determining a mapping relationship between the depth image and the color image comprises:
in response to obtaining one frame of the depth image of the target scene, obtaining one frame of the color image;
obtaining first pixel information of the color image and second pixel information of the depth image; and
determining the mapping relationship between the depth image and the color image according to the first pixel information and the second pixel information.

10. The device according to claim 9, wherein the obtaining a depth image and a color image of a target scene, and determining a mapping relationship between the depth image and the color image further comprises:
obtaining second pose information of a second color camera corresponding to the color image and third pose information of a depth camera corresponding to the depth image; and
associating the second pose information of the second color camera corresponding to the color image with the third pose information of the depth camera corresponding to the depth image according to the mapping relationship.

11. The device according to claim 8, wherein the obtaining a two-dimensional point cloud image according to the depth image, and determining a target map box corresponding to the two-dimensional point cloud image comprises:
converting the depth image into three-dimensional point cloud data, wherein the three-dimensional point cloud data carries different color identifiers;
obtaining the two-dimensional point cloud image by using the three-dimensional point cloud data; and
determining the target map box according to the two-dimensional point cloud image.

12. The device according to claim 11, wherein the determining the target map box according to the two-dimensional point cloud image comprises:
determining, according to the two-dimensional point cloud image, coordinate information of each track point in the two-dimensional point cloud image;
determining a maximum horizontal coordinate point, a minimum horizontal coordinate point, a maximum vertical coordinate point, and a minimum vertical coordinate point based on the coordinate information of each track point; and
determining a rectangular bounding box according to the maximum horizontal coordinate point, the minimum horizontal coordinate point, the maximum vertical coordinate point, and the minimum vertical coordinate point, and using the rectangular bounding box as the target map box.

13. The device according to claim 12, wherein the determining the target map box according to the two-dimensional point cloud image further comprises:
modifying the target map box by aligning the target map box with a coordinate system corresponding to the coordinate information.

14. The device according to claim 11, wherein the obtaining position label information in each region in the target map box comprises:
performing a gridding operation on the target map box to obtain each region in the target map box;
obtaining boundary information of each region, position information of each track point in each region, and a projection relationship between each track point in each region and the three-dimensional point cloud data; and
using the boundary information of each region, the position information of each track point in each region, and the projection relationship between each track point in each region and the three-dimensional point cloud data as the position label information.

15. A non-transitory computer-readable storage medium, storing a program, wherein the program, when executed by a processor, causes the processor to perform operations comprising:
obtaining a depth image and a color image of a target scene, and determining a mapping relationship between the depth image and the color image;
obtaining a two-dimensional point cloud image according to the depth image, and determining a target map box corresponding to the two-dimensional point cloud image; and
obtaining position label information in each region in the target map box, and according to the position label information and the mapping relationship, correlating the position label information to first pose information of a first color camera corresponding to a color image in each region to obtain the two-dimensional map.

16. The medium according to claim 15, wherein the obtaining a depth image and a color image of a target scene, and determining a mapping relationship between the depth image and the color image comprises:
in response to obtaining one frame of the depth image of the target scene, obtaining one frame of the color image;
obtaining first pixel information of the color image and second pixel information of the depth image; and
determining the mapping relationship between the depth image and the color image according to the first pixel information and the second pixel information.

17. The medium according to claim 16, wherein the obtaining a depth image and a color image of a target scene, and determining a mapping relationship between the depth image and the color image further comprises:
obtaining second pose information of a second color camera corresponding to the color image and third pose information of a depth camera corresponding to the depth image; and
associating the second pose information of the second color camera corresponding to the color image with the third pose information of the depth camera corresponding to the depth image according to the mapping relationship.

18. The medium according to claim 15, wherein the obtaining a two-dimensional point cloud image according to the depth image, and determining a target map box corresponding to the two-dimensional point cloud image comprises:
converting the depth image into three-dimensional point cloud data, wherein the three-dimensional point cloud data carries different color identifiers;
obtaining the two-dimensional point cloud image by using the three-dimensional point cloud data; and
determining the target map box according to the two-dimensional point cloud image.

19. The medium according to claim 18, wherein the determining the target map box according to the two-dimensional point c image comprises:
determining, according to the two-dimensional point cloud image, coordinate information of each track point in the two-dimensional point cloud image;
determining a maximum horizontal coordinate point, a minimum horizontal coordinate point, a maximum vertical coordinate point, and a minimum vertical coordinate point based on the coordinate information of each track point; and
determining a rectangular bounding box according to the maximum horizontal coordinate point, the minimum horizontal coordinate point, the maximum vertical coordinate point, and the minimum vertical coordinate point, and using the rectangular bounding box as the target map box.

20. The medium according to claim 19, wherein the obtaining position label information in each region in the target map box comprises:
performing a gridding operation on the target map box to obtain each region in the target map box;
obtaining boundary information of each region, position information of each track point in each region, and a projection relationship between each track point in each region and the three-dimensional point cloud data; and
using the boundary information of each region, the position information of each track point in each region, and the projection relationship between each track point in each region and the three-dimensional point cloud data as the position label information.
